(19) United States
(12) Patent Application Publication
(10) Pub. No.: US 2016/0190793 A1
(43) Pub. Date: Jun. 30, 2016

(54) SURGE PROTECTOR ASSEMBLY

(71) Applicant: David Ledbetter, Adairsville, GA (US)

(72) Inventor: David Ledbetter, Adairsville, GA (US)

(21) Appl. No.: 14/587,181

(22) Filed: Dec. 31, 2014

(51) Int. Cl. H02H 3/10; H01H 85/20; H01H 85/04; H01R 13/684

(52) U.S. Cl. CPC H02H 3/10; H01R 13/684; H01H 85/20; H01H 85/04; H01H 2223/04

(57) ABSTRACT

A surge protector assembly includes an electronic device. A housing has a bottom side, a top side and a peripheral wall extending therebetween. The top side is open. A breaker is positioned within the housing. The breaker is coupled to an upper surface of the bottom side. A first cord extends through a back side of the peripheral wall and is electrically coupled to the breaker. The first cord has a distal end with respect to the housing. The distal end has a first plug electrically coupled thereto. The first plug is electrically coupled to a power source. A second cord extends through a front side of the peripheral wall and is electrically coupled to the breaker. The second cord has a distal end with respect to the housing. The distal end of the second cord has a second plug electrically coupled thereto. The second plug is electrically coupled to the electronic device.

### BACKGROUND OF THE DISCLOSURE

### Field of the Disclosure

The disclosure relates to protector devices and more particularly pertains to a new protector device for protecting an electronic device from a voltage surge that may pass through a breaker box.

### SUMMARY OF THE DISCLOSURE

An embodiment of the disclosure meets the needs presented above by generally comprising an electronic device. A housing has a bottom side, a top side and a peripheral wall extending therebetween. The top side is open. A breaker is positioned within the housing. The breaker is coupled to an upper surface of the bottom side. A first cord extends through a back side of the peripheral wall and is electrically coupled to the breaker. The first cord has a distal end with respect to the housing. The distal end has a first plug electrically coupled thereto. The first plug is electrically coupled to a power source. A second cord extends through a front side of the peripheral wall and is electrically coupled to the breaker. The second cord has a distal end with respect to the housing. The distal end of the second cord has a second plug electrically coupled thereto. The second plug is electrically coupled to the electronic device.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a surge protector assembly according to an embodiment of the disclosure.

FIG. 2 is a top view of an embodiment of the disclosure.

FIG. 3 is a left side view of an embodiment of the disclosure.

FIG. 4 is a schematic view of an embodiment of the disclosure.

FIG. 5 is an in-use view of an embodiment of the disclosure.

### DESCRIPTION OF THE PREFERRED EMBODIMENT

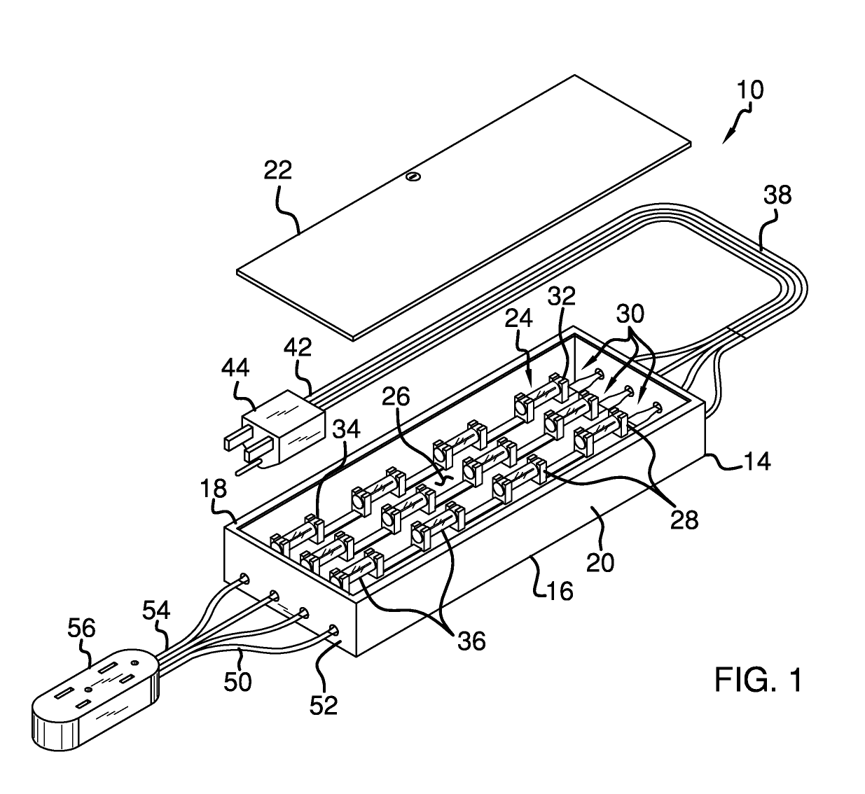

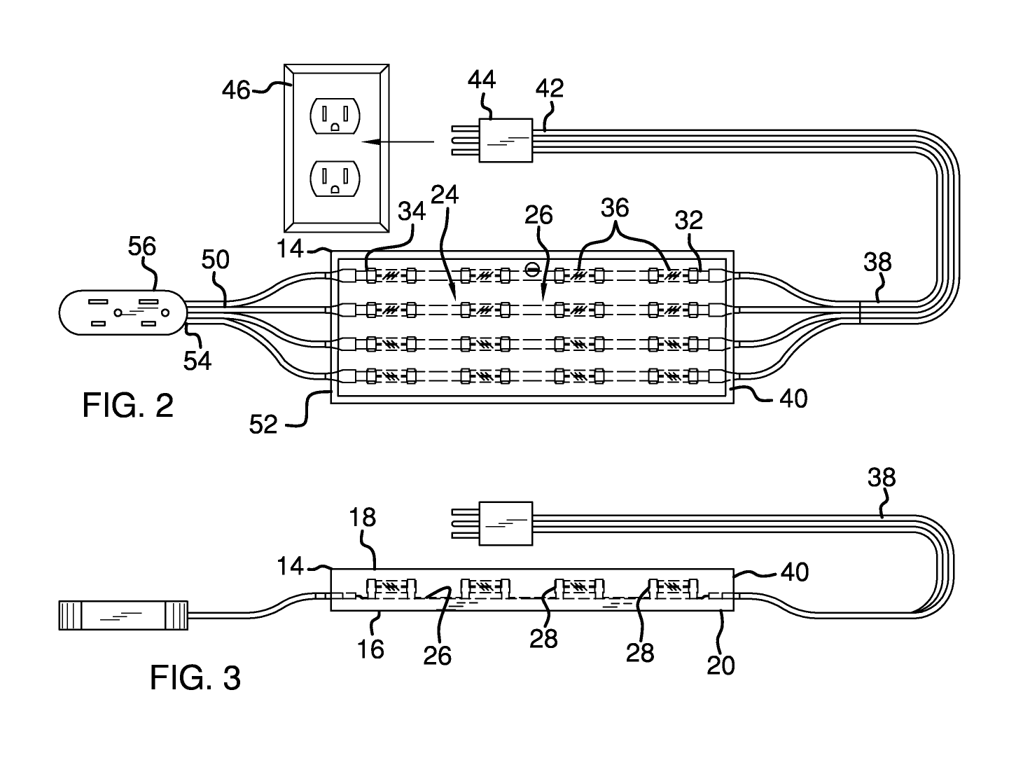

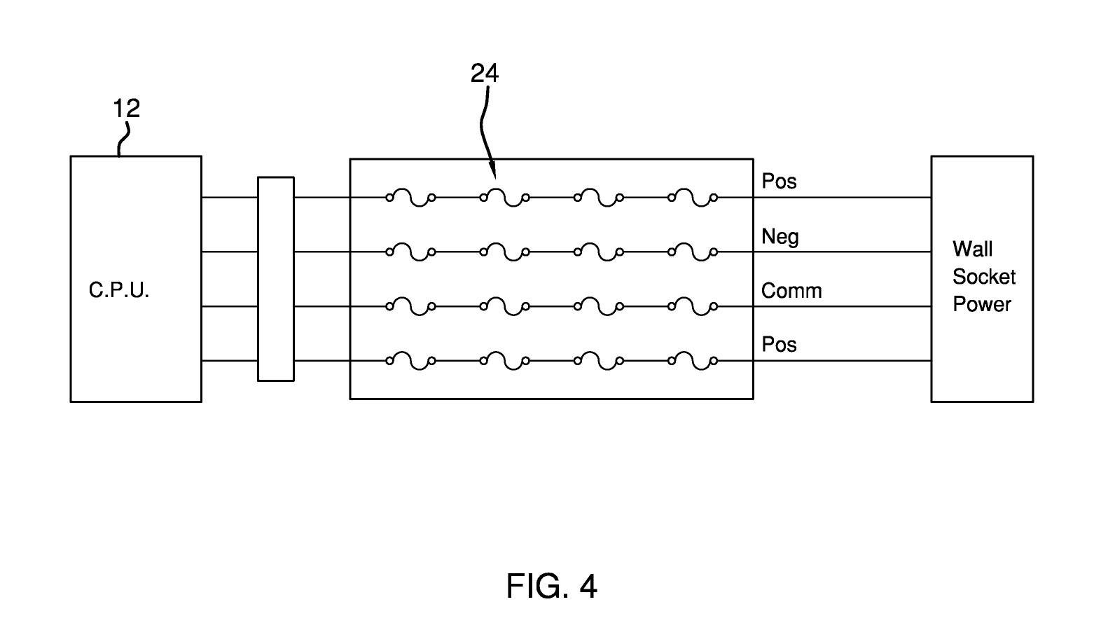

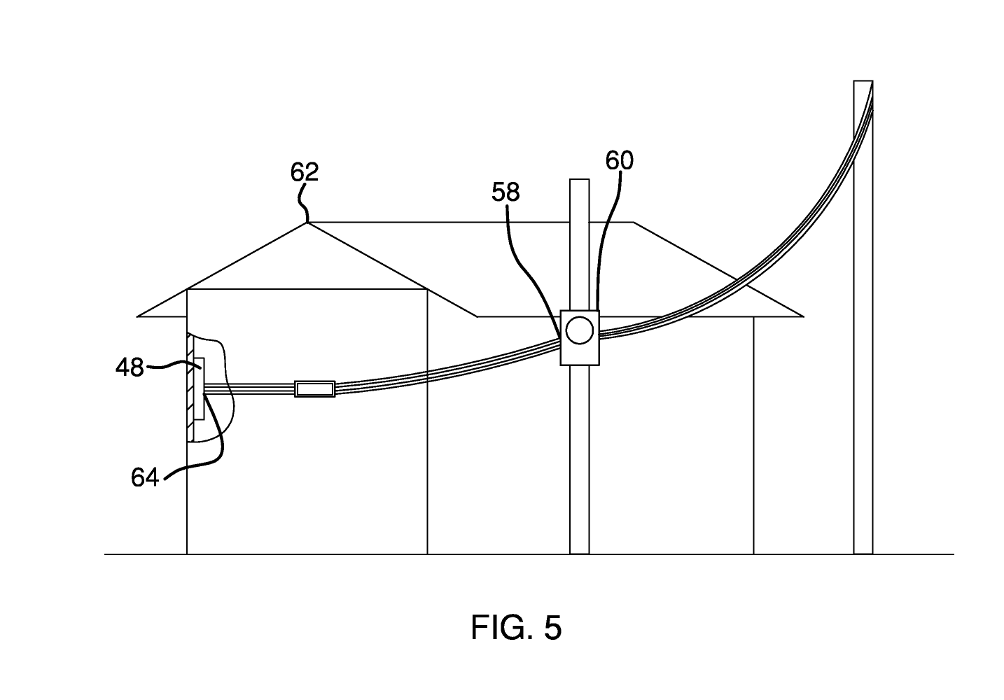

With reference now to the drawings, and in particular to FIGS. 1 through 5 thereof, a new protector device embodying the principles and concepts of an embodiment of the disclosure and generally designated by the reference numeral 10 will be described.

As best illustrated in FIGS. 1 through 5, the surge protector assembly 10 generally comprises an electronic device 12. The electronic device 12 may be a personal computer, a dvd player or other personal electronic device. A housing 14 has a bottom side 16, a top side 18 and a peripheral wall 20 extending therebetween. The top side 18 is open. A lid 22 is provided to removably close the top side 18.

A breaker 24 is positioned within the housing 14 and is coupled to an upper surface 26 of the bottom side 16. The breaker 24 includes a plurality of receptacles 28 coupled to the upper surface 26 of the bottom side 16. The receptacles 28 are arranged into a plurality of rows 30. The receptacles 28 in each of the rows 30 are electrically coupled together. Each of the rows 30 has an input receptacle 32 and an output receptacle 34. The receptacles 28 may be fuse blocks or the like.

A plurality of fuses 36 is provided. Each of the fuses 36 is positionable within an associated one of the receptacles 28 to completing a circuit across the receptacles 28. Each of the plurality of fuses 36 has a voltage rating and an amperage rating. Selected ones of the fuses 36 are positionable within each of the receptacles 28 matching an operational voltage and amperage of the electronic device 12. The fuses 36 may be glass body fuses of any conventional design. The fuses 36 may have operational voltages ranging between 20 VAC and 120 VAC. Additionally, the fuses 36 may have operational amperages ranging between 100 MA and 1 A.

A first cord 38 extends through a back side 40 of the peripheral wall 20 and is electrically coupled to the input receptacle 32 of each of the rows 30. The first cord 38 has a distal end 42 with respect to the housing 14. The distal end 42 has a first plug 44 electrically coupled thereto. The first plug 44 is electrically coupled to a power source 46. The first plug 44 may be a male electrical plug of any conventional design. The power source 46 may be an electrical outlet or the like serviced by a breaker box 48.

A second cord 50 extends through a front side 52 of the peripheral wall 20 and is electrically coupled to the output receptacle 34 of each of the rows 30. The second cord 50 has a distal end 54 with respect to the housing 14. The distal end 54 of the second cord 50 has a second plug 56 electrically coupled thereto. The second plug 56 is electrically coupled to the electronic device 12. The second plug 56 may comprise a pair of female electrical plugs of any conventional design. More than one electronic device 12 may be electrically coupled to the second plug 56.

Alternatively, the first cord 38 may be electrically coupled to an output 58 of an electrical meter 60 servicing a building 62. The second cord 50 may be electrically coupled to an input 64 of the breaker box 48 servicing the building 62. The assembly 10 may prevent voltage or amperage surges from being sent into the breaker box 48.

In use, the selected fuses are positioned within the receptacles to provide the desired level of surge protection for the electronic device. A voltage surge that is insufficient to trip the breaker box but is sufficient to damage the electronic device is prevented from being absorbed by the electronic device.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A surge protector assembly configured to have a selectable voltage and a selectable current, said assembly comprising:
an electronic device;
a housing;
a breaker positioned within said housing, said breaker being coupled to an upper surface of said bottom side; and
a first cord extending through said housing and being electrically coupled to said breaker, said first cord having a distal end with respect to said housing, said distal end having a first plug electrically coupled thereto, said first plug being electrically coupled to a power source; and
a second cord extending through said housing and being electrically coupled to said breaker, said second cord having a distal end with respect to said housing, said distal end of said second cord having a second plug electrically coupled thereto, said second plug being electrically coupled to said electronic device.

2. The assembly according to claim 1, wherein has a bottom side, a top side and a peripheral wall extending therebetween, said top side being open;

3. The assembly according to claim 2, wherein said breaker comprises a plurality of receptacles coupled to said upper surface of said bottom side.

4. The assembly according to claim 3, wherein said receptacles are arranged into a plurality of rows, said receptacles in each of said rows being electrically coupled together, each of said rows having an input receptacle and an output receptacle.

5. The assembly according to claim 3, further including a plurality of fuses each being positionable within an associated one of said receptacles thereby completing a circuit across said receptacle.

6. The assembly according to claim 5, wherein each of said plurality of fuses has a voltage rating and an amperage rating, selected ones of said fuses being positionable within each of said receptacles matching an operational voltage and amperage of said electronic device.

7. A surge protector assembly configured to have a selectable voltage and a selectable current, said assembly comprising:
an electronic device;
a housing having a bottom side, a top side and a peripheral wall extending therebetween, said top side being open;
a breaker positioned within said housing, said breaker being coupled to an upper surface of said bottom side, said breaker comprising:
a plurality of receptacles coupled to said upper surface of said bottom side, said receptacles being arranged into a plurality of rows, said receptacles in each of said rows being electrically coupled together, each of said rows having an input receptacle and an output receptacle; and
a plurality of fuses each being positionable within an associated one of said receptacles thereby completing a circuit across said receptacle, each of said plurality of fuses having a voltage rating and an amperage rating, selected ones of said fuses being positionable within each of said receptacles matching an operational voltage and amperage of said electronic device;
a first cord extending through a back side of said peripheral wall and being electrically coupled to said input receptacle of each of said rows, said first cord having a distal end with respect to said housing, said distal end having a first plug electrically coupled thereto, said first plug being electrically coupled to a power source; and
a second cord extending through a front side of said peripheral wall and being electrically coupled to said output receptacle of each of said rows, said second cord having a distal end with respect to said housing, said distal end of said second cord having a second plug electrically coupled thereto, said second plug being electrically coupled to said electronic device.
